(19) United States
(12) Patent Application Publication
(10) Pub. No.: US 2013/0168114 A1
(43) Pub. Date: Jul. 4, 2013

(54) ELECTRIC WEEDER

(71) Applicants: Toshinari Yamaoka, Nanjing (CN); Fangjie Nie, Nanjing (CN); Zhen Wang, Nanjing (CN)

(72) Inventors: Toshinari Yamaoka, Nanjing (CN); Fangjie Nie, Nanjing (CN); Zhen Wang, Nanjing (CN)

(73) Assignee: CHERVON (HK) LIMITED, Wanchai (HK)

(21) Appl. No.: 13/729,340

(22) Filed: Dec. 28, 2012

(30) Foreign Application Priority Data
Dec. 30, 2011 (CN) 201110452623.9

(51) Int. Cl. A01B 1/16

(52) U.S. Cl. CPC A01B 1/16
USPC 172/41

(57) ABSTRACT

The present invention discloses an electric weeder. The present invention provides an electric weeder, including a working head, a driving device, a connecting rod, a main handle, a removing plate, and a movable handle. The driving device is used for driving the working head to rotate; The connecting rod is used for receiving the driving device, and the working head is connected to a first end of the connecting rod; The main handle is arranged on a second end of the connecting rod opposite to the first end; The removing plate is movable relative to the working head; The movable handle includes a sleeve slidably sleeved on the connecting rod and a pushing bar. The present electric weeder can effectively enhance the efficiency of weeding and can effectively reduce the shake of the working head during the operation and enhance the comfort of operation.

### CROSS REFERENCE TO RELATED APPLICATION

This application is a non-provisional application claiming priority from Chinese Application No. CN2011/10452623.9, filed Dec. 30, 2011, and incorporated herein by reference in its entirety.

### FIELD OF THE DISCLOSURE

The present invention relates to electric tools for weeding the lawn in a garden, and more particularly to an electric weeder.

### BACKGROUND OF RELATED ART

Traditional methods for weeding a lawn include manual weeding and chemical method by spraying herbicide. In order to alleviate work load of manual weeding and enhance the efficiency of weeding, some digging tools are designed for weeding, which include manual tools and hand-held electric weeders. However, the electrical tool in the digging tools mainly needs to be operated by the user in the squatting or standing position. As for a typical short weeder, the user needs to keep the squatting position to operate the machine for a long time and it is easy to get tired. As for the relatively long weeder, the driving device is generally arranged on the upper end of the weeder near the controlling device for facilitating the user to operate the machine in a standing position. However, because the working head of the weeder is located at the lower end far away from the driving device, the tool is easy to vibrate during the operation, which decreases the comfort of the operation. In addition, the typical short and long weeders are both inconvenient to remove the lawn from the working head, thus decreasing the weeding efficiency.

### SUMMARY

An object of the present invention is to overcome the disadvantages in the prior arts, and to provide an improved electric weeder which can be comfortably operated by a user in standing position, and can increase the weeding efficiency.

The present invention provides an electric weeder, including a working head, a driving device, a connecting rod, a main handle, a removing plate, and a movable handle. The driving device is used for driving the working head to rotate; The connecting rod is used for receiving the driving device, and the working head is connected to a first end of the connecting rod; The main handle is arranged on a second end of the connecting rod opposite to the first end; The removing plate is movable relative to the working head; The movable handle includes a sleeve slidably sleeved on the connecting rod and a pushing bar, wherein one end of the pushing bar is connected to the sleeve and the other end of the pushing bar is connected to the removing plate such that the removing plate is capable of being pushed by the movable handle to move along an axial direction away from the first end of the connecting rod.

The present invention also provides an electric weeder, including a working head, a driving device, a connecting rod, a main handle, a removing plate, and a movable handle. The driving device is used for driving the working head to rotate; the working head is mounted to a first end of the connecting rod and the driving device is positioned adjacent to the first end of the connecting rod; the main handle is arranged on a second end of the connecting rod opposite to the first end; the removing plate is movable sleeved on the working head; the movable handle includes a sleeve slidably sleeved on the connecting rod and a pushing bar, wherein one end of the pushing bar is connected to the connecting rod and the other end of the pushing bar is connected to the removing plate such that the removing plate is capable of being pushed by the movable handle to move along an axial direction away from the first end of the connecting rod.

The present invention also provides an electric weeder, including a working head, a driving device, a connecting rod, a main handle, a removing plate, and a movable handle. The driving device for driving the working head to rotate; the working head is connected to a first end of the connecting rod, the driving device is positioned on the connecting rod adjacent to the working head; the main handle is arranged on a second end of the connecting rod opposite to the first end; the removing plate is movable sleeved on the working head; and the movable handle includes a sleeve slidably sleeved on the connecting rod and a pushing bar, wherein one end of the pushing bar is connected to the sleeve and the other end of the pushing bar is connected to the removing plate such that the removing plate is capable of being pushed by the movable handle to move along an axial direction away from the first end of the connecting rod.

The driving device disposed in the connecting rod, and the driving device is close to the working head, therefore the present electric weeder can effectively reduce the shake of the working head during operation and improve the comfort of operation; the removing device is simple, and the weeds-removing can be achieved by only operating the movable handle, which is convenient to be operated and more effective. Therefore, the present electric weeder can be comfortably operated by a user in standing position, and has relatively high weeding efficiency.

### BRIEF DESCRIPTION OF THE DRAWINGS

FIG. 1 is a schematic view of the electric weeder according to a first embodiment of the present invention;

FIG. 2 is a partial view of the electric weeder of FIG. 1;

FIG. 3 is a schematic view of the electric weeder according to a second embodiment of the present invention; and

FIG. 4 is a partial view of the electric weeder of FIG. 3.

### DETAILED DESCRIPTION

The present invention will be described with reference to the drawings. The following embodiments are only used to explain the technical solutions of the present invention more clearly, and cannot be used to restrict the protection scope of the present invention.

### The First Embodiment

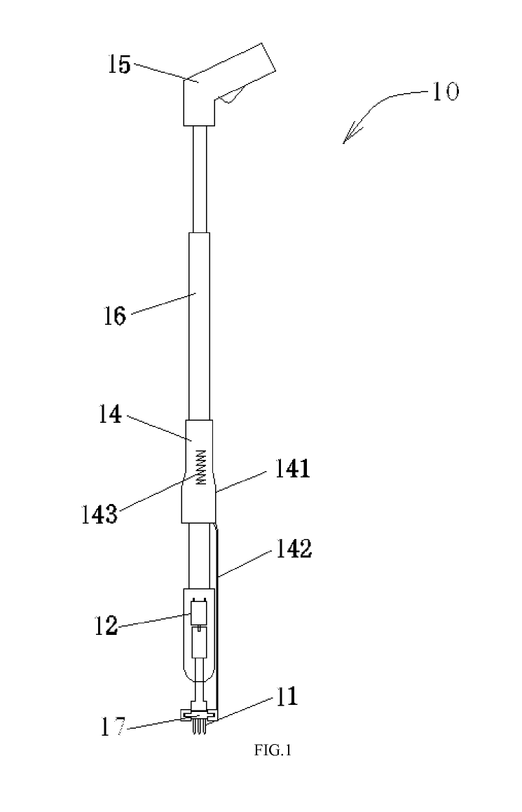

As shown in FIG. 1, the electric weeder 10 of the first embodiment includes a working head 11, a driving device 12 for driving the working head 11 to rotate, a movable handle 14, a main handle 15, an elongated connecting rod 16, and a removing plate 17 positioned adjacent to the working head 11. The driving device 12 may include a motor. The driving device 12 is fixed to a first end of the connecting rod 16 near the working head 11, and the main handle 15 is positioned on a second end of the connecting rod 16 opposite to the first end. The connecting rod 16 is a relatively long rod and suitable for the user to operate the weeder in a standing position. In the first embodiment, the connecting rod 16 could be a retractable rod, which can adjust the working length of the tool for different operators. The length of the tool may be adjusted from 50 cm to 110 cm. The driving device 21 may include a motor (not labeled). In should be note that the driving device 21 may further includes a transmission mechanism (not labeled) driven by the motor and the transmission mechanism is capable of driving the working head 11 to rotate.

The electric weeder 10 further includes a switch (not labeled) mounted on the main handle 15 for controlling the start or stop of the driving device 12.

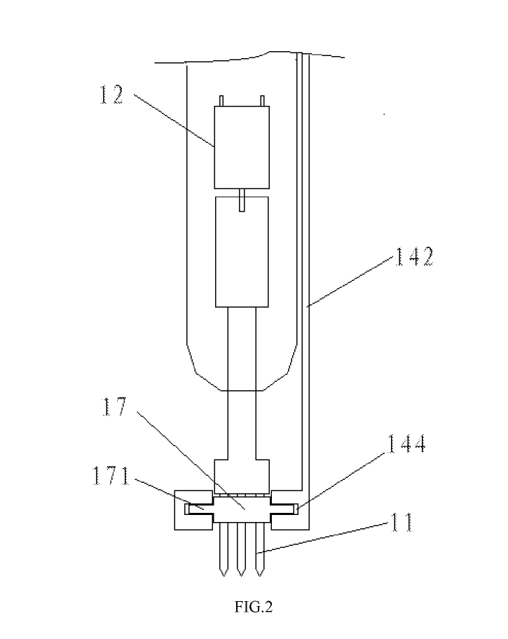

The movable handle 14 includes a sleeve 141 sleeved on the connecting rod 16 and a pushing bar 142 connected to the sleeve 141. The sleeve 141 is generally configured to be held by user's hand, and can push the movable handle 14 to move axially relatively to the connecting rod 16. As shown in FIG. 2, a first end of the pushing bar 42 is connected to the sleeve 41 and a second end opposite to the first end is connected to the removing plate 17. The outer circumference of the removing plate 17 forms a substantially circular flange 171. The second end of the pushing bar 142 forms a mounting portion (not labeled) defining a substantially circular groove 144 for receiving the flange 171 of the removing plate 17, such that the removing plate 17 is capable of being rotated freely in the mounting portion of the pushing bar 42. Meanwhile, when the pushing bar 142 and the sleeve 41 are moved axially, the removing plate 17 can be moved axially together with pushing bar 142.

The removing plate 17 defines a hole or a plurality of holes (not shown) for the working head 11 passing therethrough, such that the removing plate 17 can slide axially on the working head 11 to remove weeds from the working head 11. Since the removing plate 7 can be rotated freely in the pushing bar 42, when the working head 11 is rotated to work, the removing plate 17 can rotate together with the working head 11, but the movable handle 14 cannot be rotated. The movable handle 14 further includes a reset element 143 received in the sleeve 141 of the movable handle 14. Generally, the reset element 143 is a reset spring, such that the movable handle 14 is normally maintained in the position where the working head 11 is exposed out of the removing plate 17. When the movable handle 14 is pushed downwards and forces the removing plate 17 to move downwards along the working head 11 for removing the weeds, the reset element 13 is compressed. When weeds-removing is finished, the movable handle 14 is reset automatically under the reset force of the reset element 143.

The electric weeder is operated as follows:

When using the tool, the operator plugs the working head 11 into the soil corresponding to the root portions of the weeds, and turns on the switch. The motor 12 drives the working head 11 to rotate so that the weeds and the soil wind on the working head 11. Then, the working head 1 is drawn out, and the weeds and the soil are drawn out from the ground along with the working head 11. At this time, the movable handle 14 is pushed downwards to force the removing plate 17 to move downwards along the working head 11, therefore the drawn weeds and the soil wound on the working head 11 are pushed out. Then, the movable handle 14 is released and reset to the initial state under the action of the reset element 143.

### The Second Embodiment

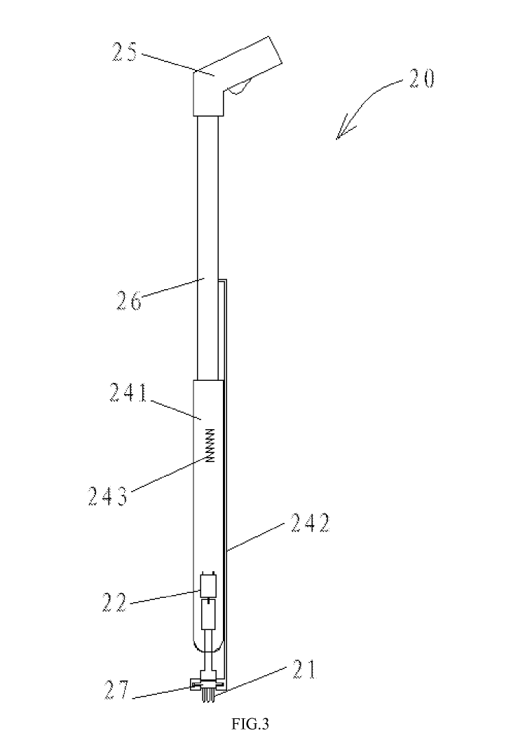

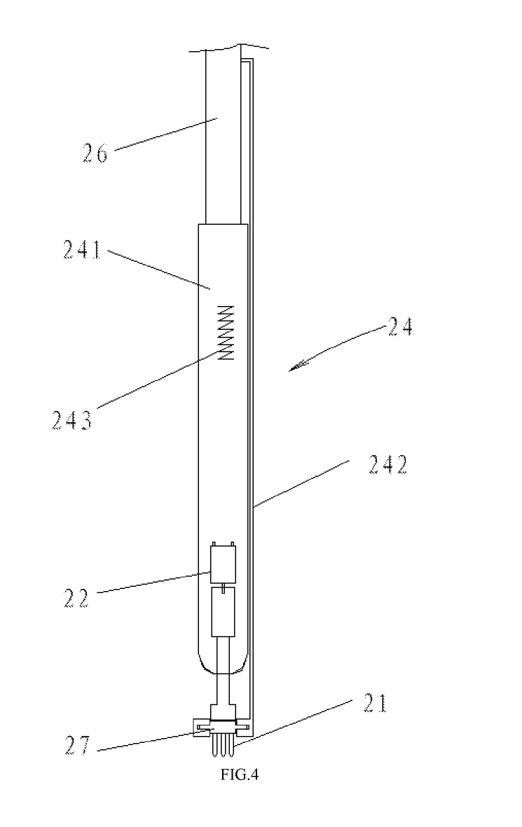

As shown in FIGS. 3 and 4, an electric weeder 20 of the second embodiment is similar in principle as the electric weeder 10 of the first embodiment. The electric weeder 20 also includes a working head 21, a driving device 22 for driving the working head 21 to rotate, a movable handle 24, a main handle 25, an elongated connecting rod 26, and a removing plate 27 positioned adjacent to the working head 21. In this embodiment, the movable handle 24 includes a sleeve 241, a pushing bar 242 and reset element 243, the sleeve 241 is slidably sleeved on the connecting rod 26. However, one end of the pushing bar 242 is connected to the connecting rod 26, and the other end of the pushing bar 242 is connected to the removing plate 27. The driving device 22 is fixed into one end of the sleeve 241 adjacent to the working head 21. The sleeve may be seen an extension of the connecting rod 26 in the first embodiment. The connecting rod 26 is a relatively long rod suitable for the operator to operate the weeder in the standing position.

The removing plate 27 defines a plurality of holes for g a plurality of working pins (not labeled) of the working head 21 passing therethrough, so the removing plate 27 may slide axially on the working head 21 so as to remove the weeds on the working head 21.

One end of the sleeve 241 could slide a predetermined distance along the end of the connecting rod 26 and the sliding distance of the sleeve 241 makes sure that the driving device 22 does not collide and interfere with the connecting rod 26.

One end of the pushing bar 242 is fixedly connected to the connecting rod 26, and the other end is connected to the removing plate 27 and removing plate 27 can be rotated axially and freely in a receiving groove (not labeled) defined in a mounting portion of the pushing bar 242. Meanwhile, when the pushing bar 42 and the connecting rod 26 are moved axially, the removing plate 27 can be moved axially together.

The reset element 243 is provided between the sleeve 241 and the connecting rod 26. The working head 21 is normally maintained by the reset element 243 in the position where the working head 21 is exposed out of the removing plate 27. When the sleeve 241 and the connecting rod 26 are moved relatively to remove the weeds, the reset element 243 is compressed. When weeds-removing is finished, the relative positions of the main handle 25, the connecting rod 26 and the sleeve 241 are reset to the initial position automatically under the reset force of the reset spring 243.

Other structures are the same as those in the first embodiment.

The electric weeder is operated as follows:

When using the tool, the operator plugs the working head 21 into the soil corresponding to the root portions of the weeds, and turns on the switch. The motor 22 drives the working head 21 to rotate so that the weeds and the soil wind on the working head 21. Then, the working head 21 is drawn out, and the weeds and the soil are drawn out from the ground along with the working head 21. By pushing the main handle 25 downwards or pulling the sleeve 241 upwards, the main handle 25 brings the connecting rod 26 to move upwards relatively along the sleeve 241 (the sleeve 241, the motor 22 and the working head 21 are connected together, and moved upwards relatively). The pushing bar 242 connected to the connecting rod 26 is also moved downwards, and brings the removing plate 27 to move downwards together along the working head 21. The weeds and the soil wound on the working head 21 are pushed out under the action of the removing plate 27. Then, the main handle 25 or the sleeve 241 is released, and the relative positions of the main handle 25, the connecting rod 26 and the sleeve 241 are reset to the initial state under the action of the reset force of the reset element 243.

The above contents are the preferred embodiments of the present invention. It should be noted that without departing the technical principle of the present invention, the person skilled in the art may make some modifications and changes to the present invention, which may be considered as a part of the protection scope of the present invention.

We claim:

1. An electric weeder, comprising:
a working head;
a driving device for driving the working head to rotate;
a connecting rod receiving the driving device, the working head being connected to a first end of the connecting rod;
a main handle arranged on a second end of the connecting rod opposite to the first end;
a removing plate movable relative to the working head; and
a movable handle including a sleeve slidably sleeved on the connecting rod and a pushing bar, wherein one end of the pushing bar is connected to the sleeve and the other end of the pushing bar is connected to the removing plate such that the removing plate is capable of being pushed by the movable handle to move along an axial direction away from the first end of the connecting rod.

2. The electric weeder according to claim 1, wherein an outer wall of the removing plate forms a flange, and the movable handle further includes a mounting portion on the end of the pushing bar connected to the removing plate, the mounting portion defines a receiving groove, the flange is rotatable received in the receiving groove.

3. The electric weeder according to claim 1, wherein the movable handle further comprises a reset element disposed between the movable handle and the connecting rod.

4. The electric weeder according to claim 1, wherein the connecting rod is a retractable rod such that the length of the connecting rod is adjustable.

5. The electric weeder according to claim 1, wherein the connecting rod is an elongated rod having a predetermined length such that the electric weeder is capable of being operated by a user in a stand position.

6. The electric weeder according to claim 1, wherein the removing plate defining a hole passed through by the working head.

7. The electric weeder according to claim 1, wherein the driving device is a motor.

8. The electric weeder according to claim 1, wherein the driving device is positioned between the sleeve and the working head, and is adjacent to the working head.

9. The electric weeder according to claim 1, wherein the driving device comprises motor and a transmission mechanism connected to the motor and the transmission mechanism is capable of driving the working head to rotate.

10. An electric weeder, comprising:
a working head;
a driving device for driving the working head to rotate;
a connecting rod, the working head being mounted to a first end of the connecting rod and the driving device being positioned adjacent to the first end of the connecting rod;
a main handle arranged on a second end of the connecting rod opposite to the first end;
a removing plate movable sleeved on the working head; and
a movable handle including a sleeve slidably sleeved on the connecting rod and a pushing bar, wherein one end of the pushing bar is connected to the connecting rod and the other end of the pushing bar is connected to the removing plate such that the removing plate is capable of being pushed by the movable handle to move along an axial direction away from the first end of the connecting rod.

11. The electric weeder according to claim 10, wherein an outer wall of the removing plate forms a flange, and the movable handle further includes a mounting portion on the end of the pushing bar connected to the removing plate, the mounting portion defines a receiving groove, the flange is rotatable received in the receiving groove.

12. The electric weeder according to claim 10, wherein the movable handle further comprises a reset element disposed between the movable handle and the connecting rod.

13. The electric weeder according to claim 10, wherein the connecting rod is a retractable rod such that the length of the connecting rod is adjustable.

14. The electric weeder according to claim 10, wherein the connecting rod is an elongated rod having a predetermined length such that the electric weeder is capable of being operated by a user in a stand position.

15. The electric weeder according to claim 10, wherein the removing plate defining a hole passed through by the working head.

16. The electric weeder according to claim 10, wherein the driving device is a motor.

17. The electric weeder according to claim 10, wherein the driving device is positioned in the sleeve.

18. An electric weeder, comprising:
a working head;
a driving device for driving the working head to rotate;
a connecting rod, the working head being connected to a first end of the connecting rod, the driving device being positioned on the connecting rod adjacent to the working head;
a main handle arranged on a second end of the connecting rod opposite to the first end;
a removing plate movable sleeved on the working head; and
a movable handle including a sleeve slidably sleeved on the connecting rod and a pushing bar, wherein one end of the pushing bar is connected to the sleeve and the other end of the pushing bar is connected to the removing plate such that the removing plate is capable of being pushed by the movable handle to move along an axial direction away from the first end of the connecting rod.

19. The electric weeder according to claim 18, wherein an outer wall of the removing plate forms a flange, and the movable handle further includes a mounting portion on the end of the pushing bar connected to the removing plate, the mounting portion defines a receiving groove, the flange is rotatable received in the receiving groove.

20. The electric weeder according to claim 18, wherein the movable handle further comprises a reset element disposed between the movable handle, and the connecting rod and the connecting rod is a retractable rod such that the length of the connecting rod is adjustable.
